(19) United States
(12) Patent Application Publication
(10) Pub. No.: US 2001/0045140 A1
(43) Pub. Date: Nov. 29, 2001

(54) TRANSMISSION INPUT SHAFT

(75) Inventors: ROGER A KAMMINGA, KALAMAZOO, MI (US); AHMAD SERESHTEH, WALLED LAKE, MI (US)

Correspondence Address: Kevin M. Hinman, Eaton Corporation, 26201 Northwestern Hwy., P.O. Box 766, Southfield, MI, 48037, US

(73) Assignee: Kevin M. Hinman

(21) Appl. No.: 09/400,255

(22) Filed: Sep. 21, 1999

(51) Int. Cl. F16D 13/52; F16H 55/17; F16H 55/08; F16H 55/10

(52) U.S. Cl. 74/434; 192/70.2

(57) ABSTRACT

A transmission input shaft (116) is provided with spline teeth (144) of an involute cross-section and a relatively small circular thickness (146).

### BACKGROUND OF THE INVENTION

1. Field of the Invention

The present invention relates to input shafts for mechanical transmissions of the type having a first end for carrying an input gear, a second end having axially extending external splines extending partially toward said first end for rotational engagement with internal splines on the driven hub of a coupling member and one or more axially extending grooves extending from the inner ends of said splines toward said first end for engaging radially inwardly extending tabs on an input shaft brake device. In particular, the present invention relates to an improved spline structure for input shafts of the type described.

2. Description of the Prior Art

Change-gear transmissions for medium- and heavy-duty vehicles and the input shafts therefor are well known in the prior art, as may be seen by reference to U.S. Pat. Nos. 5,390,561; 5,678,461; 5,441,137; 5,272,929 and 5,456,344, the disclosures of which are incorporated herein by reference. Such transmission input shafts are normally supported for rotation by bearings in the transmission housing forward wall and have a first inwardly extending end carrying an input gear and a second outwardly extending end provided with external splines for receiving the internal splines of a driven hub of a coupling member, such as a master friction clutch or torque converter, which drivingly connects the transmission input shaft to the vehicular engine. Such shafts typically have two axially extending exterior grooves, on opposite sides of the shaft, which extend from the inner ends of the splines toward the first end of the shaft for engaging inwardly extending tabs from a clutch brake/inertia brake.

Typically, the prior art input shafts had splines with relatively coarse-pitch, straight-sided spline teeth. By way of example, on a shaft splined section having a major diameter of about 1.98 to 2.00 inches, ten spline teeth having a parallel-sided tooth with a tooth thickness of about 0.306 to 0.308 inches were utilized.

The prior art input shafts were not totally satisfactory, as the incidents of spline tooth failure were higher than desirable.

### SUMMARY OF THE INVENTION

In accordance with the present invention, the drawbacks of the prior art are minimized or overcome by utilizing transmission input shafts with an improved splined structure which, in experimental tests, has shown to greatly reduce the incidents of spline tooth failure.

The foregoing is accomplished in the present invention by providing an improved input shaft spline configuration wherein the exterior splines are of a generally involute cross-section, and the number of spline teeth is increased (for example, from 10 to 14 teeth on a shaft section having about a 2.00 major diameter portion) to provide more compliant spline teeth which are less subject to cracking (especially at the roots). Use of the improved spline configuring, in testing, has greatly decreased the incidents of spline tooth failures.

Accordingly, it is an object of the present invention to provide a new and improved transmission input shaft having an improved spline tooth configuration which will improve the durability thereof.

This and other objects and advantages of the present invention will become apparent from a reading of the following description of the preferred embodiment taken in connection with the attached drawings.

### BRIEF DESCRIPTION OF THE DRAWINGS

FIG. 1 is a partiall plan view, in section, of the input end of a heavy-duty transmission including a typical prior art input shaft.

FIG. 2 is a schematic representation of a prior art input shaft.

FIG. 3 is a sectional view taken on line 3-3 in FIG. 2.

FIG. 4 is a schematic representation, similar to FIG. 2, of the input shaft of the present invention.

FIG. 5 is a sectional view taken on line 5-5 in FIG. 4.

FIG. 6 is a sectional view taken on line 6-6 on FIG. 4.

### DESCRIPTION OF THE PREFERRED EMBODIMENT

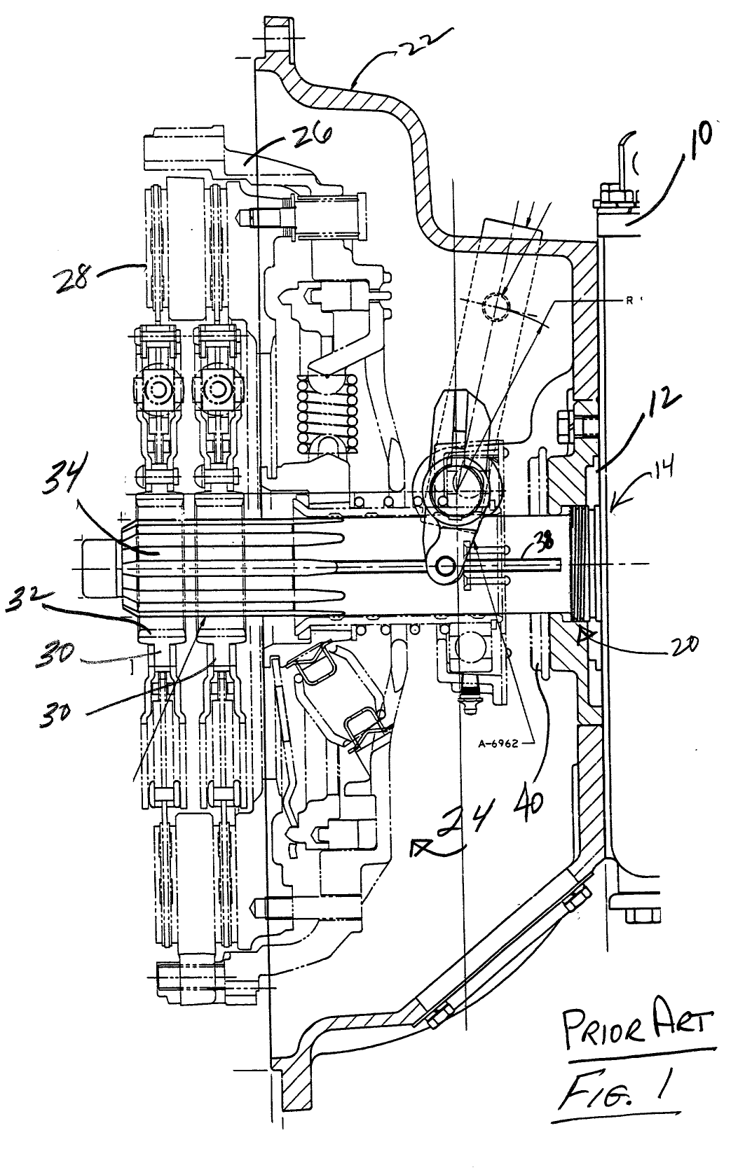

FIG. 1 illustrates the input end of a typical medium- to heavy-duty transmission (i.e., a transmission intended for vehicles having a gross combined weight of above 16,000 pounds). Such transmissions are well known in the prior art, as may be seen by way of example by reference to U.S. Pat. No. 5,390,561.

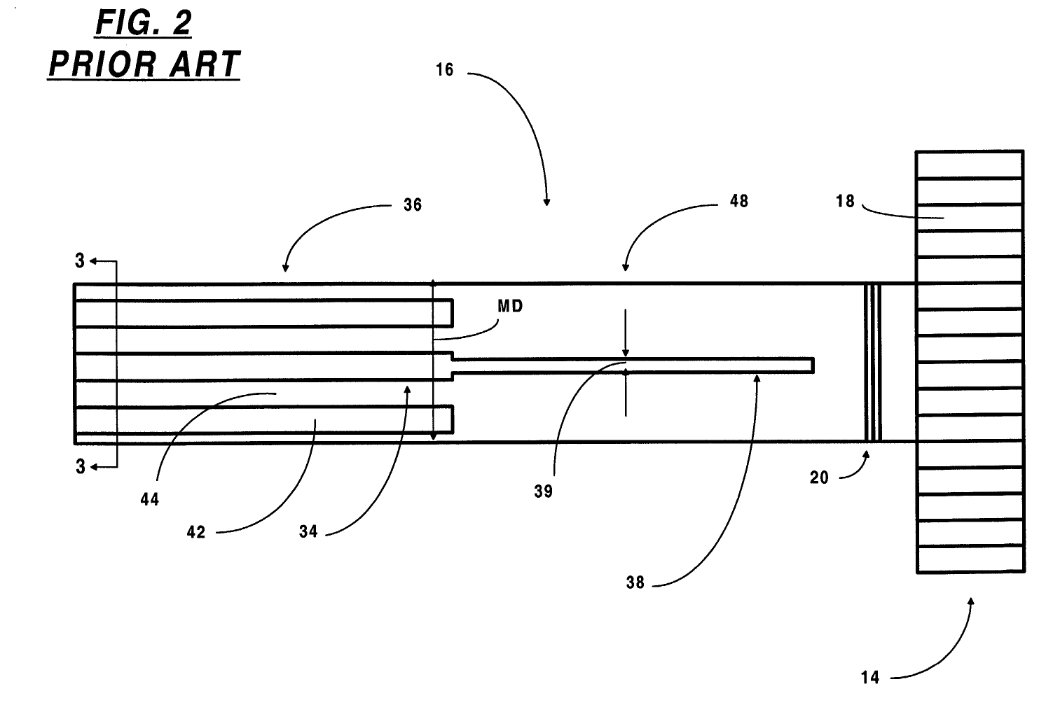

The transmission housing 10 defines an opening 12 in the forward end wall thereof for receipt of the inwardly extending or rearward end 14 of an input shaft 16. The rearward end 14 of the shaft 16 will carry an input gear 18 (see FIG. 2) for rotation therewith. The input gear 18 may be integral with the shaft 16 or separable therefrom. The end 14 also is provided with grooves 20 which will interact with seals or the like to seal the opening 12. Input shaft 16 will be of a suitable shaft and/or gear steel.

A generally bell-shaped clutch housing 22 extends from the transmission housing 10 for attachment to the rear end of a vehicular engine housing (not shown). Within the clutch housing 22 is a two-plate friction clutch 24 of well-known design. Briefly, clutch 24 includes a driving portion 26 for attachment to an engine flywheel (not shown) and two driven plates 28 having hubs 30. Hubs 30 have bores with internal splines 32 for engaging external splines 34 provided on the outwardly extending or forward end 36 of the input shaft.

Input shaft 16 defines a pair of diamentrically opposed, axially extending slots 38 in the outer periphery of an intermediate portion 48 (see FIG. 6) for receiving radially inwardly extending tabs from an inertia or clutch brake 40. As is known in the art, clutch brake 40 is a relatively low-capacity friction device, usually actuated by overtravel of the clutch pedal (not shown) to retard rotation of the input shaft for engaging a start gear. Slots 38 must be of a predetermined width 39 and depth to meet industry standards for receiving the clutch brake tabs. To allow assembly of clutch brake 40 to the shaft adjacent the rearward end 14 thereof, the tabs should align with the spaces 42 interposed the spline teeth 44 of the splined outer end 36 of the input shaft.

As may be seen by reference to FIG. 3, the spline teeth 44 of the prior art input shaft 16 are ten in number, are relatively thick (about 0.307 inch circular thickness (46)) and, as are typical splines, are substantially straight sided.

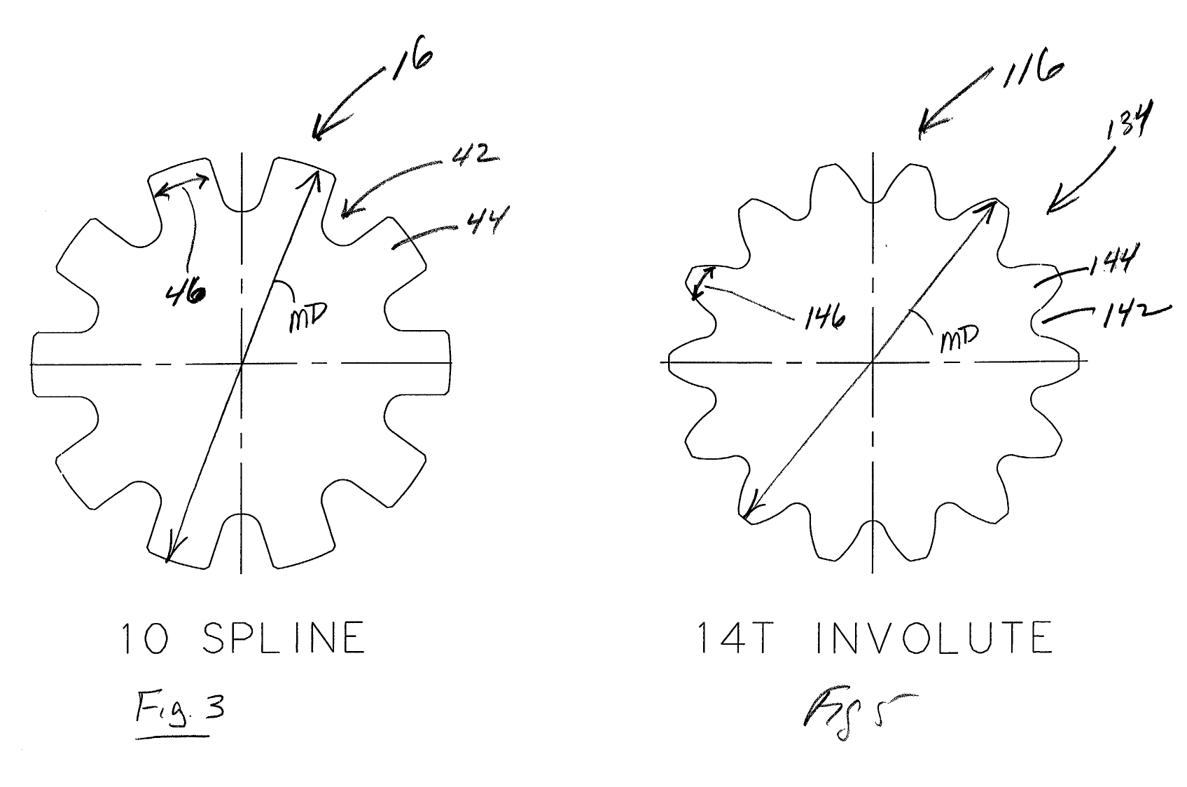

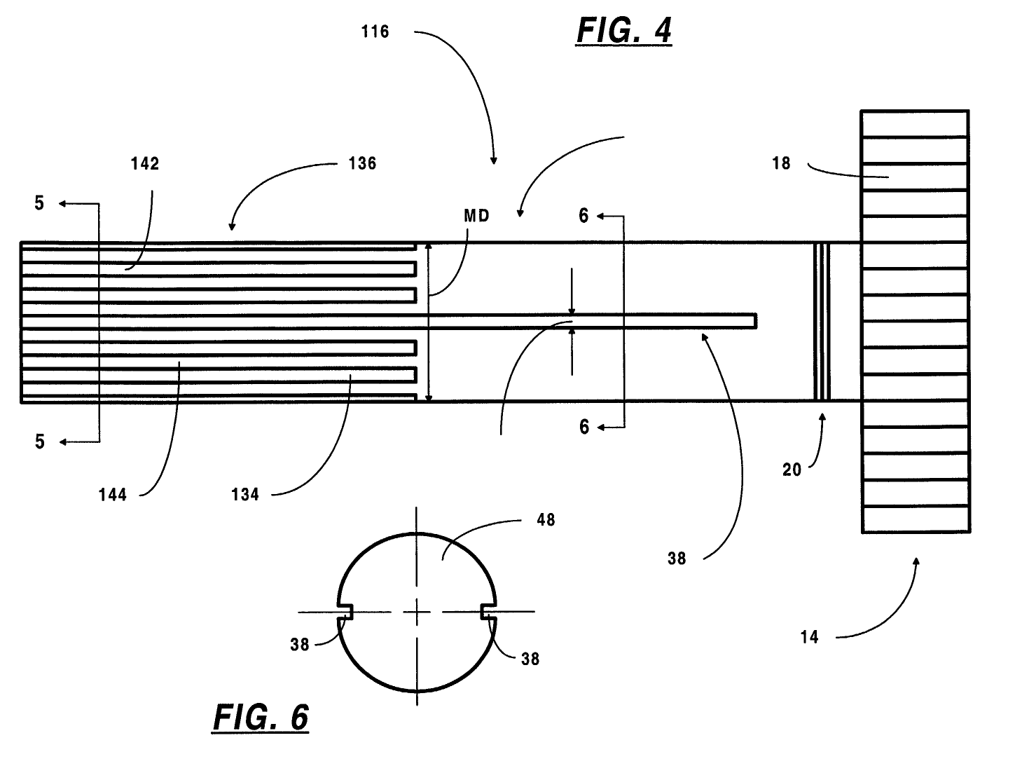

Input shaft 116 of the present invention may be seen by reference to FIGS. 4, 5 and 6. The rearward end 14 and intermediate portion 48 of input shaft 116 is structurally and functionally identical or substantially identical to the rearward end and intermediate portions of prior art input shaft 16 and will not be described again.

Shaft 11 differs from shaft 16 in the configuration of the splines 134 on forward portion 136 used to engage the splines on the clutch disc hubs. Of course, shaft 116 and hubs 30 will have complementary shaped splines.

As may be seen by reference to FIG. 5, the splines 134 are defined by spline teeth 144 separated by spaces 142, which have an involute cross-section. The teeth, and spaces, are 14 in number and are relatively thin (about 0.19 inches circular thickness (146) at a pitch diameter of about 1.75 inches) compared to the prior art clutch teeth. Both shaft 16 and section 136 of shaft 116 have a major diameter (MD) of about 1.9 to 2.0 inches. The circular thickness of the spaces 142 and teeth 144 must, of course, be at least as great as the width 39 of the slots 38.

Testing has shown that providing relatively fine pitch spline teeth 144 with a substantially involute profile greatly decreases the rate of failure of the spline teeth when used in an assembly as illustrated in FIG. 1.

The 14-tooth involute spline design of the present invention on a 2-inch diameter shaft provides an adequate tooth fillet, and adequate tooth compliance to distribute stress caused by engine torque dynamics.

Accordingly, it may be seen that by modifying the splined forward end 136 of input shaft 116, an improved transmission input shaft is provided.

Although the present invention has been described with a certain degree of particularity, it is understood that the description of the preferred embodiment is by way of example only and that numerous changes to form and detail are possible without departing from the spirit and scope of the invention as hereinafter claimed.

We claim:

1. An input shaft (116) for a vehicular transmission having a first end (14) carrying an input gear (18) and a second end (136) provided with a plurality of axially extending exterior spline teeth (144) of a major diameter in the range of about 1.90 to 2.10 inches, said teeth being at least 14 and no more than 22 in number and having a substantially involute cross-section.

2. The shaft of claim 1 wherein said spline teeth have a circular tooth thickness (146) at about a 1.75-inch pitch diameter (about 0.19 inch) of less than 70% of the tooth thickness of comparable prior art spline teeth (about 0.30 inch).

3. The shaft of claim 1 wherein said input gear (18) is integral with said shaft.

4. An input shaft (116) for a vehicular transmission having a first end (14) carrying an input gear (18) and a second end (136) provided with a plurality of axially extending exterior spline teeth (144) of known major diameter (MD), said teeth having a substantially involute cross-section and being of an even number (N) defined by the expression N≧P×MD (expressed in units of inches), where 10≧P≧6.

5. The shaft of claim 4 wherein P≧7.

6. The shaft of claim 4 wherein said input gear is integral with said shaft.

7. The shaft of claim 5 wherein said input gear is integral with said shaft.
